(19) United States
(12) Patent Application Publication
(10) Pub. No.: US 2024/0251032 A1
(43) Pub. Date: Jul. 25, 2024

(54) Vehicular Communication System for Motorists and Pedestrians

(71) Applicant: Kristian Holt, Springfield, MO (US)

(72) Inventor: Kristian Holt, Springfield, MO (US)

(21) Appl. No.: 18/406,288

(22) Filed: Jan. 8, 2024

Related U.S. Application Data
(60) Provisional application No. 63/440,459, filed on Jan. 23, 2023.

(51) Int. Cl. H04M 1/72409; H04M 1/72412

(52) U.S. Cl. CPC H04M 1/724098; H04M 1/72412

(57) ABSTRACT

The present invention is a vehicular communication system for communication between drivers and other motorists and pedestrians. The system can be integrated or retrofitted into a vehicle and includes an electronic display configured to display a text message intended to be communicated by a user of the vehicle. The user inputs a voice command in a smartphone, voice activated dashboard, or in-car entertainment console of the vehicle and a processor of the system translates the voice command into text for display on the display screen. The text is displayed for a predetermined period of time after which the text is removed automatically by the system. The system uses speech algorithms and artificial intelligence for providing correct transcription for effective communication with other users.

### CROSS-REFERENCE TO RELATED APPLICATION

The present application claims priority to, and the benefit of, U.S. Provisional Application No. 63/440,459, which was filed on Jan. 23, 2023, and is incorporated herein by reference in its entirety.

### FIELD OF THE INVENTION

The present invention relates generally to the field of communication systems for drivers. More specifically, the present invention relates to a novel vehicular communication system for showing messages to other drivers and pedestrians enabling drivers to communicate messages to other motorists. A display is mounted to the rear windshield, or another vehicle window or body area, via self-installed adhesives or magnets to display translated text of voice message of a driver of the vehicle. Each message is spoken into a smartphone, a voice activated dashboard, or an in-car entertainment console and translated text is displayed on the display screen and is intended to last for a few seconds, or for a pre-configurable period of time, and then deactivate. Accordingly, the present disclosure makes specific reference thereto. Nonetheless, it is to be appreciated that aspects of the present invention are also equally applicable to other like applications, devices, and methods of manufacture.

### BACKGROUND

By way of background, drivers driving vehicles often require communication with pedestrians and other drivers to convey messages and to provide notification of emergency situations. Communicating with other drivers and pedestrians means letting them know your intent. Drivers may want to notify another about a situation they are in or want to apologize, say sorry, prompt others, convey messages, and more to pedestrians and other drivers. Currently, drivers have to manually speak or shout to convey messages and as a result, communication may be lost and emergency situations may go unnoticed. Vehicle tools such as headlights, indicator lights, hazard lights, brake lights, horns, and more are also used for communicating messages by drivers. Use of these tools and speaking is ineffective and as a result, people may suffer serious injuries if they are unable to communicate with other people while driving.

In cases of emergency situations and lack of effective communication, people may suffer serious injuries due to accidents. Conventionally, misunderstandings can take place between drivers and other pedestrians which should be avoided. Therefore, people desire an improved way of communicating messages to other motorists and pedestrians while commuting or driving.

Therefore, there exists a long-felt need in the art for a communication system to convey different messages to other motorists and pedestrians on the road. There is also a long-felt need in the art for a communication system that eliminates the requirement of shouting, making non-verbal signs, and vehicle tools for communicating with other motorists. Additionally, there is a long-felt need in the art for a communication system that facilitates better communication between two drivers, and/or between a driver and a pedestrian(s) on the roadway. Moreover, there is a long-felt need in the art for a vehicular communication system that prevents any misunderstandings with other vehicles and pedestrians on the roadway. Further, there is a long-felt need in the art for a communication system that display intended messages of drivers to other motorists. Finally, there is a long-felt need in the art for an improved communication system that shows messages to other drivers and pedestrians for passing etiquette, apologizing, saying ‘thank you’, and more.

The subject matter disclosed and claimed herein, in one embodiment thereof, comprises a vehicular communication system for showing messages to other drivers and pedestrians without shouting or using car tool indicators and the like. The system is an integrated or retrofitted system and includes a wireless transceiver for coupling to a smartphone, a voice activated dashboard, or an in-car entertainment console of a vehicle, a processor for receiving voice commands from the coupled voice responsive smartphone, voice activated dashboard, or in-car entertainment console, wherein the voice command is spoken by a user sitting in the vehicle to the smartphone or the dashboard, a memory configured to store speech algorithms used for speech-to-text conversion, the processor converts the received voice to a text, the text is displayed on the display, which is mounted to the rear windshield (or another vehicle window area), for example, via self-installed adhesives, wherein the text is used for conveying a message to other motorists or pedestrians that are proximal to the vehicle. The text is displayed for a predetermined period of time and is automatically cleared out (i.e., erased) to make the display blank.

In this manner, the vehicular communication system of the present invention accomplishes all of the forgoing objectives and provides users with a common sense and unique communication system to convey different messages to other motorists on the road. The system features an electronic display designed to show messages spoken into a smartphone that can be mounted to the front, rear, or side windows on any make or model of vehicle. The system facilitates better communication between two drivers, and between a driver and a pedestrian(s) on the roadway to notify others of passing etiquette, apologizing, saying ‘thank you’, identifying rideshare pickup messages, and more. The system prevents any misunderstandings with other vehicles and pedestrians on the roadway or nearby, effectively improving roadway safety, communication, and rideshare identification/link up.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle communication system utilizing an electronic display for showing messages to other drivers and pedestrians. The system includes a wireless transceiver for coupling to a smartphone, voice activated dashboard, or in-car entertainment console of a vehicle, a processor for receiving voice commands from the coupled voice responsive smartphone, voice activated dashboard, or in-car entertainment console, wherein the voice commands are spoken by a user sitting in the vehicle into the smartphone or the dashboard, a memory configured to store speech algorithms used for speech-to-text conversion, the processor converts the received voice to a text, the text is displayed on the display which is mounted to the rear windshield, side window, and/or front windshield via self-installed adhesives, or on a body surface via magnets, wherein the text is used for conveying a message to other motorists and/or pedestrians on the road or proximal thereto.

In yet another embodiment, the vehicle communication system is integrated in the vehicle during manufacturing of the vehicle.

In yet another embodiment, the vehicle communication system is retrofitted as an aftermarket product.

In a further embodiment of the present invention, a vehicle with an integrated vehicular communication system is disclosed. The vehicle features a front windshield, a rear windshield, and side windows, the vehicular communication system includes a processor for translating voice messages to text, a wireless transceiver to wirelessly connect to a smartphone of a user sitting inside the vehicle, or to wirelessly connect to the dashboard of the vehicle, the smartphone or the dashboard is configured to receive a voice message through the microphone thereof, a display device having an LED panel mounted on one or both of the front windshield and the rear windshield, or on the vehicle body surfaces, wherein the display device is configured to display the text translated from the voice message for a predetermined period of time, wherein the predetermined period of time is set in a timer module of the system.

In a further embodiment of the present invention, a method for communicating a message to other motorists and pedestrians by a driver of a vehicle is described. The method comprising the steps of providing a vehicular communication system, the system having an LED display mounted on the rear windshield, a wireless transceiver for connecting the system to a smartphone of the driver, a processor for receiving a voice message from the smartphone and translating the voice message to text wherein the voice message is spoken into microphone of the smartphone. The text is displayed for a predetermined period of time on the display and the text is subsequently automatically removed from the display after the predetermined period of time, thereby creating, or reverting back to, a blank display.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of a vehicular communication system of the present invention in accordance with the disclosed architecture;

FIG. 2 illustrates a schematic view of communication of the wireless transceiver of the system with a smartphone of a user for communicating voice messages in accordance with the disclosed architecture;

FIG. 3 illustrates a perspective view showing a user sitting in a vehicle using the vehicular communication system of the present invention for communicating messages with other motorists in accordance with the disclosed architecture;

FIG. 4 illustrates a rear perspective view of the vehicle with the display device of the communication system mounted thereon in accordance with the disclosed architecture;

FIG. 5 illustrates an exemplary interface displayed on the smartphone when the smartphone is coupled with the vehicular communication system of the present invention in accordance with the disclosed architecture;

FIG. 6 illustrates a layered view of the display device used in the electronic display communication system of the present invention in accordance with the disclosed architecture; and

FIG. 7 illustrates a flow diagram depicting a process of use of the system of the present invention for displaying a message to other motorists and pedestrians in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a communication system to convey different messages to other motorists and pedestrians on the road. There is also a long-felt need in the art for a communication system that obviates shouting, making non-verbal signs, and using vehicle tools for communicating with other motorists or pedestrians. Additionally, there is a long-felt need in the art for a communication system that facilitates better communication between two drivers and other pedestrians on the roadway or pedestrian walkways. Moreover, there is a long-felt need in the art for a vehicular communication system that prevents any misunderstandings with other vehicles and pedestrians on the roadway. Further, there is a long-felt need in the art for a communication system that can display intended messages of drivers to other motorists and pedestrians. Finally, there is a long-felt need in the art for an improved communication system that shows messages to other drivers and pedestrians for passing etiquette, apologizing, saying ‘thank you’, and more.

The present invention, in one exemplary embodiment, is a method for communicating a message to other motorists and pedestrians by a driver of a vehicle. The method comprising the steps of providing a vehicular communication system, the system having an illuminated display (i.e., LED display)mounted on the rear windshield or vehicle body surface, a wireless transceiver for connecting the system to a smartphone of the driver, a processor for receiving voice messages from the smartphone and translating the voice messages to text wherein the voice messages are spoken into a microphone of the smartphone. The text is displayed for a predetermined period of time on the display and the text is automatically removed from the display after the predetermined period of time, creating a blank display.

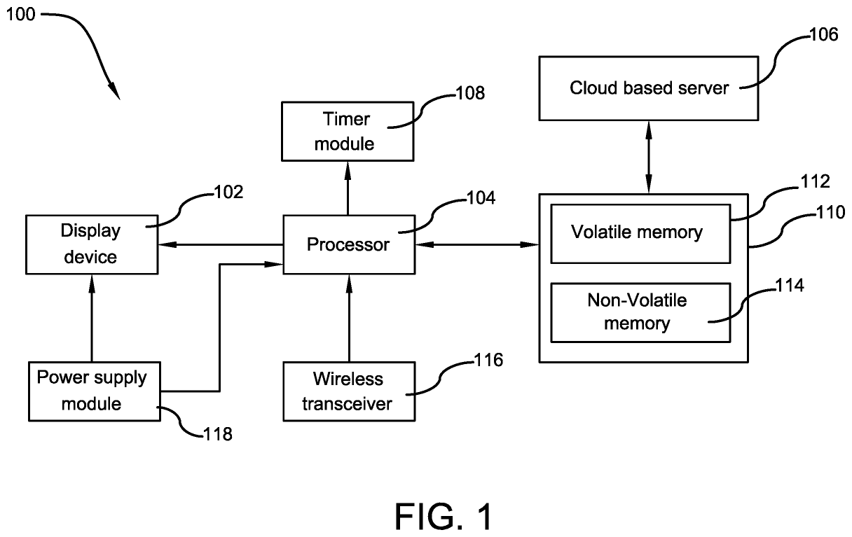

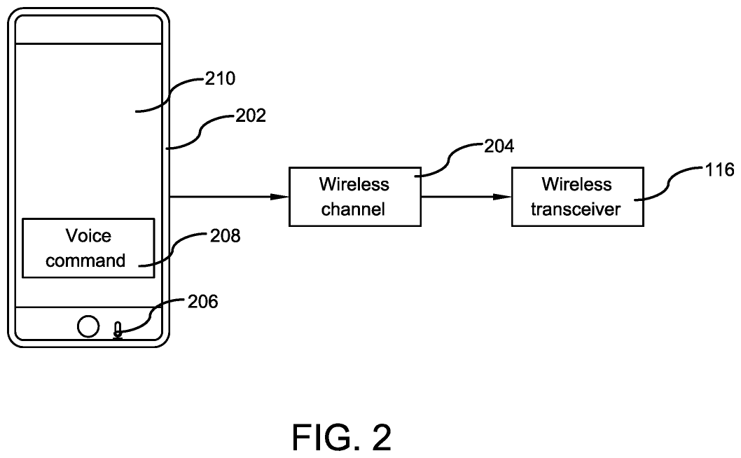

Referring initially to the drawings, FIG. 1 illustrates a schematic view of the vehicular communication system of the present invention in accordance with the disclosed architecture. The communication system 100 of the present invention is configured to communicate different messages to other motorists and pedestrians without requiring a driver or other passengers of a vehicle to shout or use any existing car tools. More specifically, the system 100 is installed in a vehicle and includes a display 102 with self-installed adhesive to mount to the rear windshield, or with magnets to mount to the vehicle body surface. The system 100 is coupled (i.e., connected) to a smartphone of a user or voice activated dashboard, or in-car entertainment console of the vehicle as illustrated in FIG. 2 enabling the user to speak voice commands into the coupled voice responsive smartphone or the dashboard, or in-car entertainment console wherein the display 102 is configured to display the voice commands in a textual form for other motorists and pedestrians to view the voice command and to be notified about a driver communication.

A processor 104 is configured to translate the voice commands of the user to a text for display on the display device 102. The processor 104 has speech-to-text capabilities and may include advanced artificial intelligence to help boost transcription accuracy and helps in translating rare words or phrases. In one exemplary embodiment, the speech algorithms run locally in the processor 104 regardless of any internet connectivity for converting speech to text. In another exemplary embodiment, the speech algorithms can be run through the ‘cloud’ by sending recorded samples to a cloud server or source 106 for processing. In addition, the smartphone can use its built-in voice-to-text functionality (i.e., SIRI) for translating voice commands of the user. The algorithms are constantly updated from the cloud source 106 to improve the transcription process. The algorithms can be updated through a general source locally, as well as, through the cloud source 106. The processor 104 is also configured to handle ambient noise in order to provide integrated noise cancellation.

The display 102 is configured to display a translated text message for a predetermined period of time, for example, 5 seconds, 10 seconds, 15 seconds, 30 seconds, and more, thereafter, the text is deactivated to clear the display 102. The predetermined period of time period can be predefined by a user using the coupled voice responsive smartphone and is monitored by a timer control module 108 of the system 100. A machine-readable memory 110 of the system 100 is configured to store speech algorithms and language library to facilitate effective and correct translation. The memory 110 can include volatile memory 112 and nonvolatile memory 114. By way of illustration, and not limitation, nonvolatile memory 114 can include read only memory (ROM), programmable ROM (PROM), electrically programmable ROM (EPROM), electrically erasable programmable ROM (EEPROM), flash memory, or nonvolatile random-access memory (RAM) (e.g., ferroelectric RAM (FeRAM)). Volatile memory 112 can also include random-access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

A wireless transceiver 116 is configured to provide a wireless channel for communication of the system 100 with the coupled voice responsive smartphone, voice activated dashboard, or in-car entertainment console of the vehicle. The wireless channel, by way of illustration, and not limitation, can be Wi-Fi, Bluetooth, WiMax, Zigbee, and can be in the form of any Intra-vehicle communication protocol. In one exemplary embodiment, the wireless transceiver 116 is a short-range radio receiver used for beacon messaging or direct messaging. The wireless transceiver 116 enables the processor 104 to receive speech from the coupled device. A power supply module 118 is configured to receive electric supply for working of the system 100 from a low voltage supply (i.e., 12V battery) or circuit of the vehicle. The power supply module 118 enables the system 100 to work from electric supply of the vehicle and therefore, obviates use of any external power supply.

The term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches, and gates, in order to optimize space usage or enhance performance of user equipment. A processor can also be implemented as a combination of computing processing units.

The processor 104 and the memory 110 together helps in training of the speech algorithms using integrated training module wherein updates in the algorithms are received from the cloud server 106. The system 100 can be easily used and in different embodiments of the present invention, the display 102 can be mounted to different parts of a vehicle including, but not limited to, front, rear, side windows, and more.

FIG. 2 illustrates a schematic view of communication of the wireless transceiver of the system 100 with a smartphone of a user for communicating voice messages in accordance with the disclosed architecture. As illustrated, the system 100 using the wireless transceiver 116 is coupled to a smartphone 202 via a wireless channel 204. The smartphone 202 can be any smartphone of a user sitting inside a vehicle in which the system 100 is installed. The wireless channel 204 is preferably a low energy Bluetooth channel, but can be any intra-vehicle communication protocol.

The microphone 206 of the smartphone 202 is used for receiving voice messages of the user and the speech is translated into text by the processor 104 of the system 100 and is displayed on the display device 102. The translation into text by the processor 104 can be through the native voice-to-text processor resident on the smartphone 202. A voice command prompt 208 on display 210 of the smartphone 202 is used for activating the microphone 206 for capturing sound of the user. It should be appreciated that the system 100 obviates a user from shouting, making non-verbal signs, and using vehicle tools for communicating with other motorists and pedestrians.

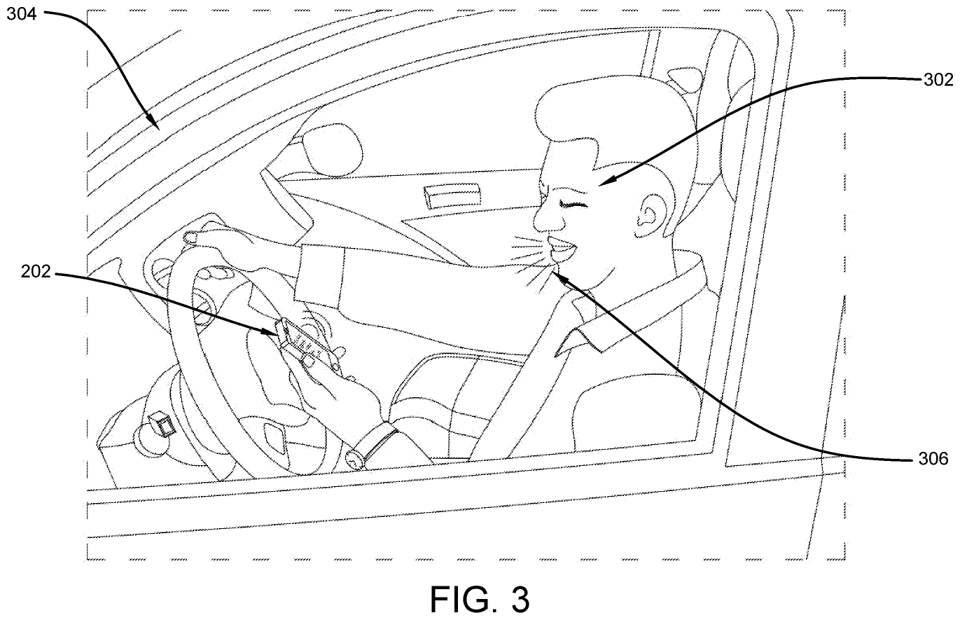

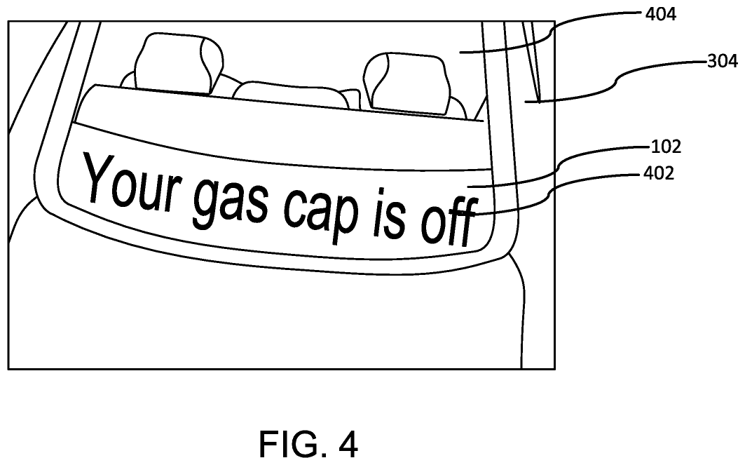

FIG. 3 illustrates a perspective view showing a user sitting in a vehicle using the vehicular communication system of the present invention for communicating messages with other motorists in accordance with the disclosed architecture. As illustrated, the user 302 uses the smartphone 202 which is coupled with the system 100 installed in the vehicle 304 for providing one or more voice commands 306. The user 302 can be any user sitting in the vehicle 304 and the system 100 as described in FIG. 1 receives and translates the voice message to display the text 402 on the display device 102 positioned on a rear windshield 404 as illustrated in FIG. 4.

The text message is also displayed on the display of the smartphone 202 enabling the user 302 to verify the message that is displayed on the display device 102. The text message 402 is displayed for a predetermined period of time after which the text message 402 is automatically cleared out. The system 100 allows drivers to communicate any type of message to other motorists and pedestrians. As a result, the system 100 facilitates better communication between two drivers and other pedestrians on the roadway to notify others of passing etiquette, hazards/problems, apologizing, saying ‘thank you’, and more. The display text 402 can be in the form of an illuminated text (i.e., LED in red) or any other color which can be visible from long distances.

It should be appreciated that based on design of the vehicle and preference of the users, the display 102 can be mounted to any area of the vehicle and further, the system 100 can be integrated during manufacturing of the vehicle or retrofitted to the vehicle as an aftermarket product.

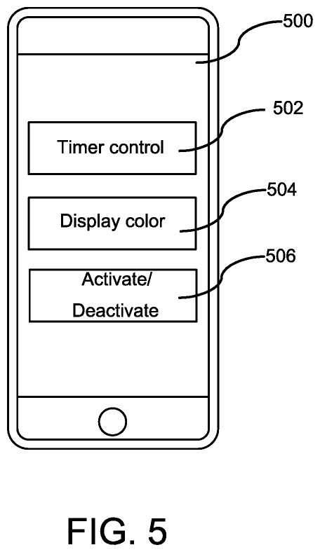

FIG. 5 illustrates an exemplary interface displayed on the smartphone 202 when the smartphone 202 is coupled with the vehicular communication system of the present invention in accordance with the disclosed architecture. The interface 500 is displayed by a smartphone application installed in the smartphone and is configured to control the system 100. A timer control tab 502 allows a user to control and configure the preconfigured time (the timer module) for which the display device 102 displays the text message, emojis, images, and/or gifs. Any time up to, for example, one minute can be configured by the user using the timer control tab 502. Using the display color tab 504, the user configures the color of the text displayed on the display device 102. Based on the preference of the user, any conventional primary or secondary color can be selected to display the text.

The user can manually activate or deactivate the communication system 100 based on the requirements using the activate/deactivate tab 506. By default, the system 100 automatically activates when the vehicle ignition starts by receiving power from the vehicle. It should be appreciated that when the smartphone 202 couples with the system 100, the user interface 500 is displayed to the user enabling the user to control the system 100. More specifically, in some embodiments of the present invention, a computer-implemented software application displaying different configuration options can be installed by the user in the smartphone to control the operations of the system.

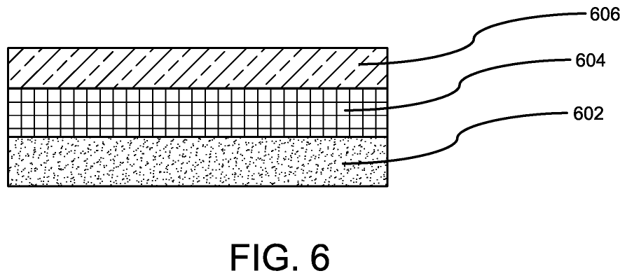

FIG. 6 illustrates a layered view of the display device 102 used in the electronic display communication system of the present invention in accordance with the disclosed architecture. The display device 102 includes a bottom adhesive layer 602 that is configured to removably attach to any metallic or non-metallic surface of a vehicle. The adhesive layer 602 is waterproof and does not create any impact on the vehicle. A printed circuit board (PCB) 604 is sandwiched between the adhesive layer 602 and an illuminated panel (i.e., LED panel) 606. Both the PCB 604 and the illuminated panel 606 are flexible to conform to the shape of the surface on which the display 102 is mounted. The illuminated panel 606 also generates the text which is translated from the speech received by the processor of the system 100.

The illuminated panel 606 can be wiped in order to clean the surface. The illuminated panel 606 does not emit heat. Further, the text is bright enabling other motorists and pedestrians to easily view the text. Further, the text is clear and focused both during day and night and the display 102 is durable and manages both heat and light.

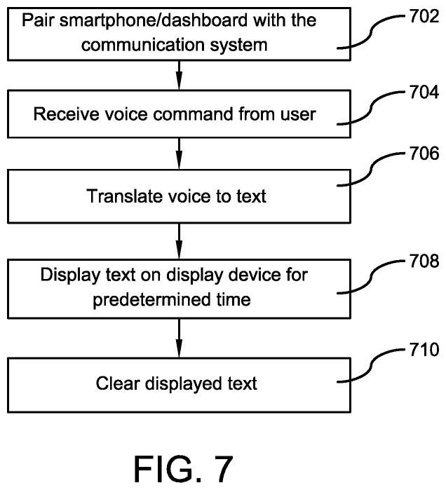

FIG. 7 illustrates a flow diagram depicting a process of use of the system 100 of the present invention for displaying a message to other motorists and pedestrians in accordance with the disclosed architecture. Initially, a smartphone or a dashboard is paired with the system 100 using a wireless channel inside the vehicle in which the system is installed (Step 702). Then, using the smartphone or the dashboard, a voice command intended to be sent by a user to other motorists or pedestrians is received (Step 704). Thereafter, the voice message is received and translated into a text message by the processor of the system (Step 706).

Then, the text translated from the voice message is displayed on the display device mounted on an appropriate position on the exterior (or interior) of the vehicle (Step 708). It should be noted that the text is displayed only for a predetermined and preselected period of time on the display device 102 and after that the text is automatically cleared and the display device becomes blank (Step 710).

The communication system 100 can include a short-range radio receiver (using Bluetooth low energy) in the device as a way to convey messages directly to the driver. The short-range radio receiver can be integrated into the vehicle's infotainment system, integrated into an after-market add-in, displayed on the user's cell phone, or read out loud. The short-range radio receiver enables two new features with these additions, namely beacons and direct messaging.

Beacons can be installed or located at various positions and used to broadcast an identifier and optional information via short-range radio. If no message is included, then the identifier can be looked up via a database either local to the device or stored in the cloud.

Information from the beacon can then be optionally displayed or read to the user. Messages can be selected from the group comprising advertisements for products, parking information, facility contact information, emergency response information, or anything of interest to drivers. Beacon messages can be categorized based on the type of message transmitted and users can opt-out of message categories, or opt-out altogether.

Direct messaging includes messaging from one driver or device to another driver or device. For example, Driver A in a blue Honda Pilot allows Driver B to merge in congested traffic.

Driver B keys their Traffic Talk Device B and states “Tell the driver (i.e., Driver A) in the blue Honda Pilot “thank you””. Device B translates the voice command into a message ‘thank you’ and a set of metadata “blue Honda pilot”. Device B then broadcasts an encrypted message via short-range radio (such as Bluetooth Low Energy) containing the parsed metadata. Driver A's traffic talk equipped Honda Pilot responds that there is a metadata match. Device B transmits the requested message to Device A which displays it to the user.

Metadata can be interpreted as “Data about data.” In the aforementioned example, metadata is information about the vehicle the communication system 100 or ‘Traffic Talk device’ is installed into. Metadata can include information such as the make and model of the car, license plate number, distinguishing physical features such as “large dent on passenger's side” or “Coexist” bumper sticker. Metadata can be user-selectable. Devices should support both read-only and user-editable options. Some Metadata, such as vehicle make/model, can be set by the manufacturer while other Metadata can be customized by the user. Direct messaging feature can be continually listening for transmissions from other compatible devices, but can be restricted from transmitting unless instructed to by the user, or following pre-programmed rules enabled by the user. This will prevent ‘bad actors’ from passively tracking users and enables users to opt-out of anything that could potentially be used to track them. In order for one device to connect to another device the following sequence can occur. Device A generates a random connection identifier and broadcasts on a common frequency the ID, a set of metadata it is looking for, and a connection request. Device B receives the broadcast and compares the bundled metadata to its own internal metadata table. Device A depends on what information the user provides. Device B can also run through a security scan to see if Device A is banned from the service for any reason. Once Device B determines there is a match it sends a message back to Device A and the two devices begin negotiating a secure connection using for example a Diffie-Helman process to exchange keys. Once a key is selected, Device B sends a metadata match challenge to Device A which compares it to any other received match requests and determines which device is the most likely one the user is requesting to connect to. In some cases, the user may be prompted for additional details. Once a connection to the proper device is established, Device A transmits its message and leaves the connection open for a predetermined amount of time to allow Device B to respond. If Device B does not respond the connection closes and all shared security information is discarded from both devices.

In another example, a Device C is not an initial metadata match and so it does not respond to Device A's initial message request. Further, a Device D is determined to be a ‘bad actor’ and does respond, but because Device A is looking for more detailed metadata information it discards Device D's connection attempt.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicular communication system”, “communication system”, “electronic display communication system”, and “system” are interchangeable and refer to the inter-vehicular communication system 100 of the present invention.

Not withstanding the forgoing, the inter-vehicular communication system 100 of the present invention can be of any suitable size and configuration as is known in the art without affecting the overall concept of the invention, provided that it accomplishes the above-stated objectives. One of ordinary skill in the art will appreciate that the inter-vehicular communication system 100 as shown in the FIGS. is for illustrative purposes only, and that many other sizes and shapes and steps for the inter-vehicular communication system 100 are well within the scope of the present disclosure. Although the dimensions and configuration of the inter-vehicular communication system 100 are important parameters for user convenience, the inter-vehicular communication system 100 may be of any size that ensure optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A communication system installed in a vehicle comprising:
a processor;
a display; and
a connection to a remote transceiver;
wherein said display mounted to a vehicle;
wherein said display is outward from said vehicle;
wherein said transceiver receives a voice message and communicates said voice message to said processor;
wherein said processor translates said voice message into a textual form and displays said textual form on said display; and
further wherein said display is visible to another outside of said vehicle.

2. The communication system installed in a vehicle of claim 1, wherein said mounting having a self-installed adhesive for attachment to a window of said vehicle.

3. The communication system installed in a vehicle of claim 2, wherein said transceiver receives said voice message from a smartphone.

4. The communication system installed in a vehicle of claim 2, wherein said transceiver receives said voice message from an in-car entertainment console of said vehicle.

5. The communication system installed in a vehicle of claim 3, wherein said display is an illuminated display.

6. The communication system installed in a vehicle of claim 1, wherein said another is a pedestrian outside of said vehicle and proximal to said vehicle.

7. The communication system installed in a vehicle of claim 1, wherein said another is a motorist driving another vehicle proximal to said vehicle.

8. The communication system installed in a vehicle of claim 1, wherein said processor having a speech-to-text conversion processor.

9. The communication system installed in a vehicle of claim 2, wherein said display having a timer control module for displaying said translated text message for a predetermined period of time.

10. The communication system installed in a vehicle of claim 9, wherein said predetermined period of time is from 5 seconds to 30 seconds.

11. The communication system installed in a vehicle of claim 10, wherein said translated text message is cleared after said predetermined period of time has expired.

12. The communication system installed in a vehicle of claim 11, wherein said communication system having a power supply module for receiving electrical power from a 12V vehicle battery.

13. The communication system installed in a vehicle of claim 12, wherein said processor is selected from a group consisting of a single-core processor, a single-processor with software multithread execution capability, a multi-core processor, multi-core processor with software multithread execution capability, a multi-core processor with hardware multithread technology, a parallel platform, and a parallel platform with distributed shared memory.

14. The communication system installed in a vehicle of claim 12, wherein said window is selected from a group consisting of a vehicle front window, a vehicle side window, and a vehicle rear window.

15. A communication system installed in a vehicle comprising:
a processor;
a display; and
a transceiver;
wherein said display having a mounting mounted to a vehicle;
wherein said display is outward from said vehicle;
wherein said transceiver receives a voice message and communicates said voice message to said processor;
wherein said processor translates said voice message into a textual form and displays said textual form on said display;
wherein said transceiver receives said voice message through a wireless Bluetooth channel; and
further wherein said display is visible to another outside of said vehicle.

16. The communication system installed in a vehicle of claim 15, wherein said mounting
having a self-installed adhesive for attachment to a window of said vehicle; and
further wherein said window is selected from a group consisting of a vehicle front window, a vehicle side window, and a vehicle rear window.

17. The communication system installed in a vehicle of claim 15, wherein said transceiver receives said voice message from an in-car entertainment console of the vehicle.

18. The communication system installed in a vehicle of claim 15, wherein said another is a pedestrian outside of said vehicle and proximal to said vehicle.

19. The communication system installed in a vehicle of claim 15, wherein said another is a motorist driving another vehicle proximal to said vehicle.

20. A communication system installed in a vehicle comprising:
a processor;
a display; and
a transceiver;
wherein said display is mounted to a vehicle and is visible to another outside of said vehicle;
wherein said transceiver receives a beacon message and communicates said beacon message to said processor;
wherein said processor translates said beacon message into a textual form and displays said textual form on said display; and
further wherein said transceiver receives said beacon message through a short-range radio transmitter.
